(19) United States
(12) Patent Application Publication
(10) Pub. No.: US 2026/0280710 A1
(43) Pub. Date: Sep. 17, 2026

(54) DISTORTION ESTIMATION DEVICE, RECEIVER, AND DISTORTION ESTIMATION METHOD

(71) Applicant: NEC Corporation, Tokyo (JP)

(72) Inventor: Masaki SATO, Tokyo (CN)

(73) Assignee: NEC Corporation, Tokyo (JP)

(21) Appl. No.: 19/473,853

(22) PCT Filed: Apr. 24, 2023
(86) PCT No.: PCT/JP2023/016100

§ 371 Date: Oct. 9, 2025

(51) Int. Cl. H04B 10/2507; H04B 10/61; H04J 14/06

(52) U.S. Cl. CPC H04B 10/2507; H04B 10/61; H04J 14/06

(57) ABSTRACT

A receiver receives a polarization multiplexed signal that has been transmitted from a transmitter via a transmission path. An equalization filter performs an equalization process on the received signal to which nonlinear distortion has been applied in at least one of the transmitter, the transmission path, and the receiver. A coefficient update unit adaptively controls respective filter coefficients of an in-receiver distortion compensation filter, a transmission path distortion compensation filter, and an in-transmitter distortion compensation filter. A distortion detection unit, after convergence of the filter coefficients, detects distortion in the receiver on the basis of the filter coefficient of the in-receiver distortion compensation filter and detects distortion in the transmitter on the basis of the filter coefficient of the in-transmitter distortion compensation filter.

### DESCRIPTION

### Technical Field

The present disclosure relates to a distortion estimation device, a receiver, a communication system, a distortion estimation method, and a computer-readable medium.

### Background Art

In an optical transmission system, in order to realize high-speed communication of 1 Tbit/s (bits per second) or more, modulation schemes such as a high symbol rate and high-order Quadrature Amplitude Modulation (QAM) are required. Since the introduction of the digital coherent reception technology, flexible equalization signal processing on a receiver side by digital signal processing has been enabled. However, in general, high-order multi-level modulation signals are vulnerable to distortion. In the advanced multi-level modulation scheme, highly accurate equalization processing is required to ensure performance.

As a related art, PTL 1 discloses a coherent optical receiver in a polarization-multiplexed digital coherent optical communication system. In PTL 1, an optical receiver includes an equalization signal processing circuit including an adaptive multilayer filter. The adaptive multilayer filter includes an in-receiver distortion compensation filter, a chromatic dispersion compensation filter, a polarization demultiplexing filter, a carrier phase compensation filter, and an in-transmitter distortion compensation filter in this order from a signal input side. In PTL 1, coefficients of the in-receiver distortion compensation filter, the polarization demultiplexing filter, and the in-transmitter distortion compensation filter are adaptively controlled based on an output of the in-transmitter distortion compensation filter and a desired state.

The optical receiver described in PTL 1 includes an in-transmitter distortion detection unit and an in-receiver distortion detection unit. After convergence of coefficient adaptive control of the adaptive multilayer filter, the in-transmitter distortion detection unit detects in-transmitter distortion based on the coefficients of the in-transmitter distortion compensation filter. After convergence of coefficient adaptive control of the adaptive multilayer filter, the in-receiver distortion detection unit detects in-receiver distortion based on the coefficients of the in-receiver distortion compensation filter. In PTL 1, the in-transmitter distortion detection unit and the in-receiver distortion detection unit detect IQ imbalance, IQ skew, and IQ phase mismatch as in-transmitter distortion and in-receiver distortion, respectively.

As another related art, PTL 2 discloses an equalization signal processing circuit in a receiver. The equalization signal processing circuit disclosed in PTL 2 includes an adaptive multilayer filter including an in-receiver distortion compensation filter, a chromatic dispersion compensation filter, a polarization demultiplexing filter, a carrier phase compensation filter, and an in-transmitter distortion compensation filter. In PTL 2, the adaptive multilayer filter further includes an in-receiver nonlinear distortion compensation filter at the preceding stage of the in-receiver distortion compensation filter that compensates for linear distortion. In PTL 2, the adaptive multilayer filter further includes an in-transmitter nonlinear distortion compensation filter at a subsequent stage of the in-transmitter distortion compensation filter that compensates for linear distortion.

### CITATION LIST

### Patent Literature

PTL 1: WO 2022/091452 A1
PTL 2: JP 2022-174467 A

### SUMMARY OF INVENTION

### Technical Problem

In PTLs 1 and 2, the adaptive multilayer filter in the receiver collectively and adaptively compensates for distortion occurring in a transmitter device (hereinafter, also referred to as in-transmitter distortion) and distortion occurring in a receiver device (hereinafter, also referred to as in-receiver distortion distortion). However, distortion included in a reception signal and commonly present in in-phase (I) and quadrature (Q) components (hereinafter, also referred to as common distortion) is commutative between the in-transmitter distortion and the in-receiver distortion. Therefore, in a case where the in-transmitter distortion and the in-receiver distortion are collectively compensated for by the adaptive multilayer filter, it is difficult to separate the common distortion in the transmitter and the common distortion in the receiver. In the adaptive multilayer filter, there is also a problem that the common distortion of the transmitter and the common distortion of the receiver are compensated for by a 2×2 Multiple-Input and Multiple-Output (MIMO) equalizer used for the polarization demultiplexing filter. Due to such a problem, there is a problem that the in-transmitter distortion and the in-receiver distortion cannot be accurately detected from the coefficient of the in-transmitter distortion compensation filter and the coefficient of the in-receiver distortion compensation filter, respectively.

In view of the above circumstances, an object of the present disclosure is to provide a distortion estimation device, a receiver, a communication system, a distortion estimation method, and a computer-readable medium capable of accurately detecting in-transmitter distortion and in-receiver distortion.

Solution to Problem In order to achieve the above object, the present disclosure provides a distortion estimation device as a first aspect. The distortion estimation device includes: an equalization filter that includes an in-receiver distortion compensation filter that compensates for in-receiver distortion occurring in a polarization-multiplexed signal in a receiver that receives the polarization-multiplexed signal transmitted from a transmitter via a transmission path, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter, and performs equalization processing on a signal to which nonlinear distortion is applied in at least one of the transmitter, the transmission path, or the receiver, the signal being received by the receiver; a coefficient update unit that adaptively controls filter coefficients of the in-receiver distortion compensation filter, the transmission path distortion compensation filter, and the in-transmitter distortion compensation filter; and a distortion detection unit that detects the in-receiver distortion based on the filter coefficients of the in-receiver distortion compensation filter, and detects the in-transmitter distortion based on the filter coefficients of the in-transmitter distortion compensation filter, after convergence of the filter coefficients.

The present disclosure provides a receiver as a second aspect. The receiver includes a detector that coherently receives a polarization-multiplexed signal transmitted from a transmitter via a transmission path, and a distortion estimation device that detects distortion included in a signal based on the coherently received polarization-multiplexed signal. The distortion estimation device includes: an equalization filter that includes an in-receiver distortion compensation filter that compensates for in-receiver distortion occurring in the polarization-multiplexed signal in the receiver, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter, and performs equalization processing on a signal to which nonlinear distortion is applied in at least one of the transmitter, the transmission path, or the receiver, the signal being received by the receiver; a coefficient update unit that adaptively controls filter coefficients of the in-receiver distortion compensation filter, the transmission path distortion compensation filter, and the in-transmitter distortion compensation filter; and a distortion detection unit that detects the in-receiver distortion based on the filter coefficients of the in-receiver distortion compensation filter, and detects the in-transmitter distortion based on the filter coefficients of the in-transmitter distortion compensation filter, after convergence of the filter coefficients.

The present disclosure provides a communication system as a third aspect. The communication system includes a transmitter that transmits a polarization-multiplexed signal, a transmission path that transmits the polarization-multiplexed signal, a receiver that receives the polarization-multiplexed signal via the transmission path, and a distortion estimation device. The distortion estimation device includes: an equalization filter that includes an in-receiver distortion compensation filter that compensates for in-receiver distortion occurring in the polarization-multiplexed signal in the receiver, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter, and performs equalization processing on a signal to which nonlinear distortion is applied in at least one of the transmitter, the transmission path, or the receiver, the signal being received by the receiver; a coefficient update unit that adaptively controls filter coefficients of the in-receiver distortion compensation filter, the transmission path distortion compensation filter, and the in-transmitter distortion compensation filter; and a distortion detection unit that detects the in-receiver distortion based on the filter coefficients of the in-receiver distortion compensation filter, and detects the in-transmitter distortion based on the filter coefficients of the in-transmitter distortion compensation filter, after convergence of the filter coefficients.

The present disclosure provides a distortion estimation method as a fourth aspect. The distortion estimation method includes: performing equalization processing on a signal to which nonlinear distortion is applied in at least one of a transmitter, a transmission path, or a receiver, the signal being received by the receiver, by using an equalization filter that includes an in-receiver distortion compensation filter that compensates for in-receiver distortion occurring in a polarization-multiplexed signal in the receiver that receives the polarization-multiplexed signal transmitted from the transmitter via the transmission path, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter; adaptively controlling filter coefficients of the in-receiver distortion compensation filter, the transmission path distortion compensation filter, and the in-transmitter distortion compensation filter; and detecting the in-receiver distortion based on the filter coefficients of the in-receiver distortion compensation filter, and detecting the in-transmitter distortion based on the filter coefficients of the in-transmitter distortion compensation filter, after convergence of the filter coefficients.

The present disclosure provides a computer-readable medium as a fifth aspect. The computer-readable medium stores a program for causing a processor to execute a process, the process including: performing equalization processing on a signal to which nonlinear distortion is applied in at least one of a transmitter, a transmission path, or a receiver, the signal being received by the receiver, by using an equalization filter that includes an in-receiver distortion compensation filter that compensates for in-receiver distortion occurring in a polarization-multiplexed signal in the receiver that receives the polarization-multiplexed signal transmitted from the transmitter via the transmission path, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter; adaptively controlling filter coefficients of the in-receiver distortion compensation filter, the transmission path distortion compensation filter, and the in-transmitter distortion compensation filter; and detecting the in-receiver distortion based on the filter coefficients of the in-receiver distortion compensation filter, and detecting the in-transmitter distortion based on the filter coefficients of the in-transmitter distortion compensation filter, after convergence of the filter coefficients.

### Advantageous Effects of Invention

The distortion estimation device, the receiver, the communication system, the distortion estimation method, and the computer-readable medium according to the present disclosure can accurately detect the in-transmitter distortion and the in-receiver distortion.

### BRIEF DESCRIPTION OF DRAWINGS

FIG. 1 is a schematic block diagram illustrating a communication system according to the present disclosure.

FIG. 2 is a block diagram illustrating a schematic configuration of a receiver.

FIG. 3 is a block diagram illustrating a communication system according to a first example embodiment of the present disclosure.

FIG. 4 is a block diagram illustrating a configuration example of a digital signal processing unit.

FIG. 5 is a block diagram illustrating a configuration example of a distortion estimation unit.

FIG. 6 is a block diagram illustrating a configuration example of an adaptive equalization filter in a distortion estimation unit.

FIG. 7 is a schematic diagram illustrating a relationship among distortions that occur in an optical transmitter, a transmission path, and an optical receiver.

FIG. 8 is a flowchart illustrating an operation procedure of distortion estimation in an optical fiber communication system.

FIG. 9 is a block diagram illustrating a model of PMD in a transmission path.

FIG. 10 is a block diagram illustrating a configuration example of an adaptive equalization filter used in a second example embodiment of the present disclosure.

FIG. 11 is a block diagram illustrating a more detailed configuration of a filter configuration of a part that compensates for transmission path distortion in an adaptive equalization filter.

FIG. 12 is a block diagram illustrating a modified example of an adaptive equalization filter used in a distortion estimation unit.

FIG. 13 is a block diagram illustrating a communication system according to a third example embodiment of the present disclosure.

FIG. 14 is a block diagram illustrating a configuration example of an adaptive equalization filter of a distortion estimation unit used in a fourth example embodiment of the present disclosure.

FIG. 15 illustrates an operation procedure of filter coefficient control in a fifth example embodiment of the present disclosure.

FIG. 16 is a spectrum diagram illustrating an optical spectrum of a transmission signal measured in an experiment.

FIG. 17 is a spectrum diagram illustrating an optical spectrum of a transmission signal measured in an experiment.

FIG. 18 is a spectrum diagram illustrating an optical spectrum of a transmission signal measured in an experiment.

FIG. 19 is a spectrum diagram illustrating a spectrum of a reception signal measured in an experiment.

FIG. 20 is a spectrum diagram illustrating a spectrum of a reception signal measured in an experiment.

FIG. 21 is a spectrum diagram illustrating a spectrum of a reception signal measured in an experiment.

FIG. 22 is a block diagram illustrating a configuration example of a computer device.

### EXAMPLE EMBODIMENT

Prior to describing example embodiments of the present disclosure, an overview of the present disclosure will be given. FIG. 1 schematically illustrates a communication system according to the present disclosure. A communication system 10 includes a transmitter 11, a transmission path 13, and a receiver 15. The transmitter 11 and the receiver 15 are connected to each other via the transmission path 13. The transmitter 11 transmits a polarization-multiplexed signal to the transmission path 13. The receiver 15 receives the polarization-multiplexed signal transmitted from the transmitter 11 from the transmission path 13.

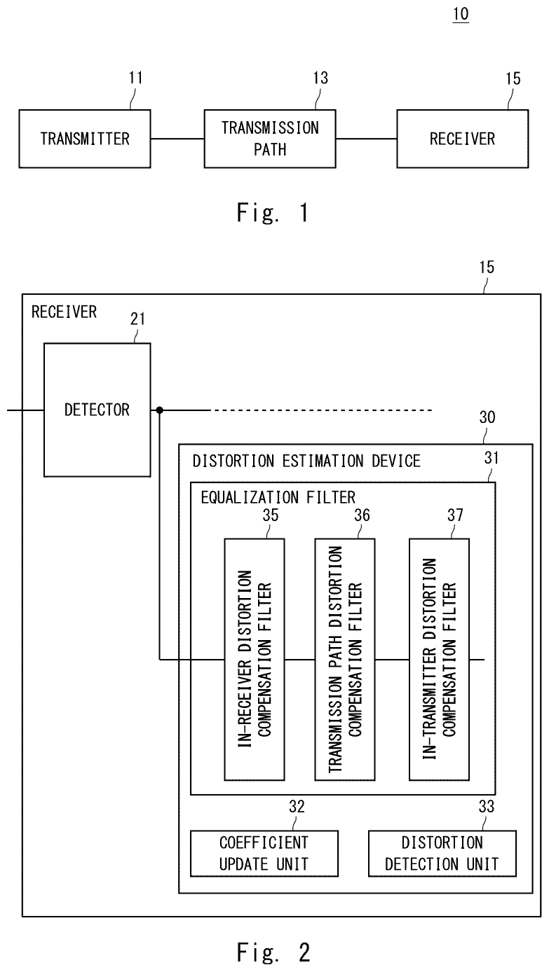

FIG. 2 illustrates a schematic configuration of the receiver 15. The receiver 15 includes a detector 21 and a distortion estimation device 30. The detector 21 coherently receives the polarization-multiplexed signal transmitted from the transmitter. The distortion estimation device 30 detects distortion included in a signal based on the coherently received polarization-multiplexed signal. In a case where distortion is detected in the distortion estimation device 30, the detector 21 outputs a signal to which nonlinear distortion is applied for the distortion estimation device 30. In the present disclosure, the distortion estimation device 30 is not necessarily included in the receiver 15. The distortion estimation device 30 may be configured as a device separate from the receiver 15.

The distortion estimation device 30 includes an equalization filter 31, a coefficient update unit 32, and a distortion detection unit 33. The equalization filter 31 performs equalization processing on a signal received by the receiver 15 and having nonlinear distortion applied in at least one of the transmitter 11, the transmission path 13, or the receiver 15. The equalization filter 31 includes an in-receiver distortion compensation filter 35, a transmission path distortion compensation filter 36, and an in-transmitter distortion compensation filter 37. The in-receiver distortion compensation filter 35 compensates for the in-receiver distortion occurring in the polarization-multiplexed signal in the receiver 15. The transmission path distortion compensation filter 36 compensates for the distortion occurring in the polarization-multiplexed signal in the transmission path 13. The in-transmitter distortion compensation filter 37 compensates for the in-transmitter distortion occurring in the polarization-multiplexed signal in the transmitter 11.

The coefficient update unit 32 adaptively controls the coefficients of the in-receiver distortion compensation filter 35, the transmission path distortion compensation filter 36, and the in-transmitter distortion compensation filter 37. After convergence of coefficients of the equalization filter 31, the in-receiver distortion compensation filter 35 is considered to have information corresponding to the characteristics of the distortion occurring in the receiver 15. The in-transmitter distortion compensation filter 37 is considered to have information corresponding to the characteristics of the distortion occurring in the transmitter 11. After convergence of filter coefficients, the distortion detection unit 33 detects the in-receiver distortion based on the filter coefficients of the in-receiver distortion compensation filter 35. The distortion detection unit 33 detects the in-transmitter distortion based on the filter coefficients of the in-transmitter distortion compensation filter 37.

In the present disclosure, the equalization filter 31 in the distortion estimation device 30 performs equalization processing on a signal to which nonlinear distortion is applied in the transmitter 11, the transmission path 13, the receiver 15, or two or more these locations. After the convergence of filter coefficients, the distortion detection unit 33 detects the in-receiver distortion based on the filter coefficients of the in-receiver distortion compensation filter 35, and detects the in-transmitter distortion based on the filter coefficients of the in-transmitter distortion compensation filter 37. In the present disclosure, the nonlinear distortion is applied to the signal input to the equalization filter 31 in at least one of the transmitter 11, the transmission path 13, or the receiver 15. In this case, IQ common distortion common to the I component and the Q component of the signal becomes non-commutative before and after a location where nonlinear distortion is applied. For example, in a case where the nonlinear distortion is applied to the signal in the transmitter 11, the IQ common distortion occurring in the transmitter 11 and the IQ common distortion occurring in the receiver 15 are non-commutative. In this case, the IQ common distortion occurring in the transmitter 11 and the IQ common distortion occurring in the receiver 15 can be separated, and the distortion detection unit 33 can accurately detect the in-transmitter distortion and the in-receiver distortion.

Hereinafter, example embodiments according to the present disclosure will be described in detail. In the following description and drawings, omission and simplification are made as appropriate for clarity of description. In each drawing, the same elements and the similar elements are denoted by the same reference numerals, and the repeated description is omitted as necessary.

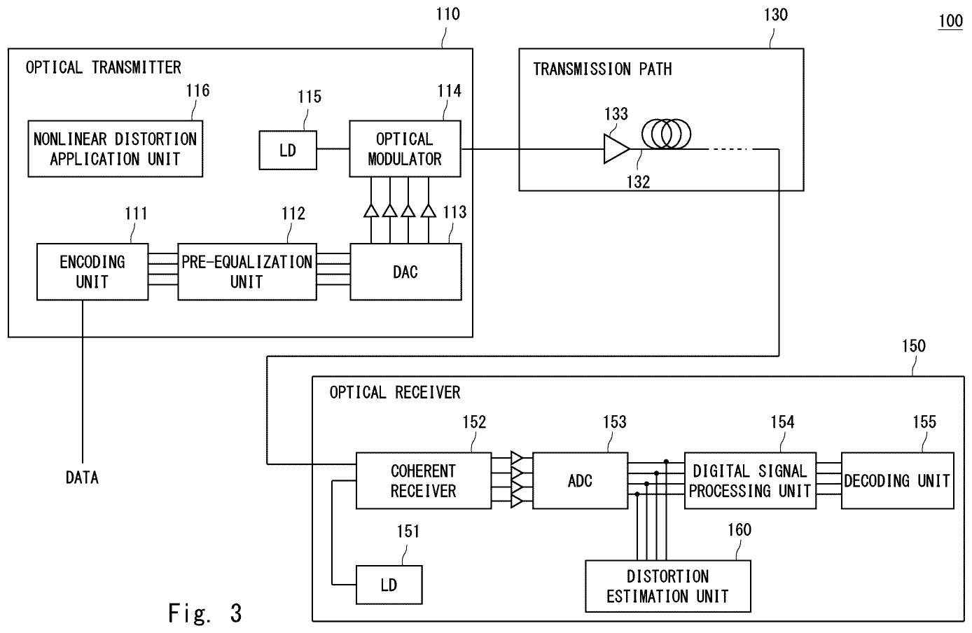

FIG. 3 illustrates a communication system according to a first example embodiment of the present disclosure. In the present example embodiment, the communication system is assumed to be an optical fiber communication system that adopts a polarization-multiplexed multi-level modulation scheme and performs coherent reception. An optical fiber communication system 100 includes an optical transmitter 110, a transmission path 130, and an optical receiver 150. The optical fiber communication system 100 constitutes, for example, an optical submarine cable system. The optical fiber communication system 100 corresponds to the communication system 10 illustrated in FIG. 1. The optical transmitter 110 corresponds to the transmitter 11 illustrated in FIG. 1. The transmission path 130 corresponds to the transmission path 13 illustrated in FIG. 1. The optical receiver 150 corresponds to the receiver 15 illustrated in FIG. 1.

The optical transmitter 110 converts a plurality of pieces of transmission data into a polarization-multiplexed optical signal. The optical transmitter 110 includes an encoding unit 111, a pre-equalization unit 112, a digital analog converter (DAC) 113, an optical modulator 114, a laser diode (LD) 115, and a nonlinear distortion application unit 116. The encoding unit 111 encodes data. The encoding unit 111 outputs, for example, four series of signals including an in-phase (I) component and a quadrature (Q) component of the X-polarized wave and the Y-polarized wave.

The pre-equalization unit 112 performs pre-equalization for compensating for distortion or the like of a device in the optical transmitter in advance for the four series of encoded signals. The pre-equalization unit 112 includes, for example, a 2×2 IQ MIMO filter for inputting and outputting an I component and a Q component for each polarization. The 2×2 IQ MIMO filter compensates for distortion occurring in the optical transmitter 110, such as distortion occurring in the I component and the Q component in each polarization and crosstalk occurring between the I component and the Q component. The pre-equalization unit 112 is also referred to as a pre-equalization filter. A DAC 113 converts each of the four series of signals on which pre-equalization has been performed into an analog electrical signal. The DAC 113 inputs the converted analog electrical signal to the optical modulator 114. An electrical amplifier is disposed between the DAC 113 and the optical modulator 114, and an analog electrical signal whose amplitude is amplified by the electrical amplifier is input to the optical modulator 114.

An LD 115 outputs continuous wave (CW) light. The optical modulator 114 is a modulator that modulates the CW light output from the LD 115 in accordance with the four series of analog electrical signals input from the DAC 113 and generates a polarization-multiplexed optical signal such as a polarization-multiplexed QAM signal. The optical modulator 114 includes, for example, a Mach-Zehnder (MZ) modulator. The optical modulator 114 transmits the generated polarization-multiplexed optical signal to the transmission path 130.

The nonlinear distortion application unit 116 causes nonlinear distortion in the polarization-multiplexed optical signal transmitted from the optical transmitter 110 to the transmission path. The nonlinear distortion application unit 116 causes nonlinear distortion in the polarization-multiplexed optical signal by, for example, saturating the output level of the DAC 113. The nonlinear distortion application unit 116 may cause nonlinear distortion in the polarization-multiplexed optical signal by saturating the input level or gain of the electrical amplifier disposed between the DAC 113 and the optical modulator 114. Alternatively, the nonlinear distortion application unit 116 may cause nonlinear distortion in the polarization-multiplexed optical signal by, for example, saturating the input level to the optical modulator 114. The nonlinear distortion application unit 116 causes nonlinear distortion in the polarization-multiplexed optical signal in a case where the in-transmitter distortion and the in-receiver distortion are estimated by a distortion estimation unit 160 to be described later.

The transmission path 130 transmits the polarization-multiplexed optical signal output from the optical transmitter 110 to the optical receiver 150. The transmission path 130 includes an optical fiber 132, and an optical amplifier 133. The optical fiber 132 guides the optical signal transmitted from the optical transmitter 110. The optical amplifier 133 amplifies the optical signal and compensates for a propagation loss in the optical fiber 132. The optical amplifier 133 is configured as, for example, an erbium doped fiber amplifier (EDFA). The transmission path 130 may include a plurality of optical amplifiers 133.

The optical receiver 150 includes an LD 151, a coherent receiver 152, an analog digital converter (ADC) 153, a digital signal processing unit 154, a decoding unit 155, and a distortion estimation unit 160. The LD 151 outputs CW light that is local oscillator light. The coherent receiver 152 is configured as a polarization diversity coherent receiver. The coherent receiver 152 performs coherent detection on an optical signal transmitted through the optical fiber 132 using the CW light output from the LD 151. The coherent receiver 152 outputs four series of reception signals (electrical signals) corresponding to the I components and the Q components of the X-polarized wave and the Y-polarized wave subjected to coherent detection. The coherent receiver 152 corresponds to the detector 21 illustrated in FIG. 2.

The reception signal output from the coherent receiver 152 is input to the ADC 153 via the electrical amplifier. The ADC 153 samples the reception signal output from the coherent receiver 152 and converts the reception signal into a digital signal. The ADC 153 outputs the converted digital signal to the digital signal processing unit 154. The digital signal processing unit 154 performs digital signal processing on the four series of reception signals sampled by the ADC 153 and demodulates the reception signal. The digital signal processing unit 154 is also referred to as a digital signal processing circuit. The digital signal processing unit 154 includes an adaptive equalization filter, and the adaptive equalization filter compensates for various types of distortion included in the digital signal. The decoding unit 155 decodes the demodulated signal and restores the transmitted data. The decoding unit 155 is also referred to as a decoder. In the optical receiver 150, circuits such as the digital signal processing unit 154 and the decoding unit 155 can be configured, for example, using a device such as a digital signal processor (DSP).

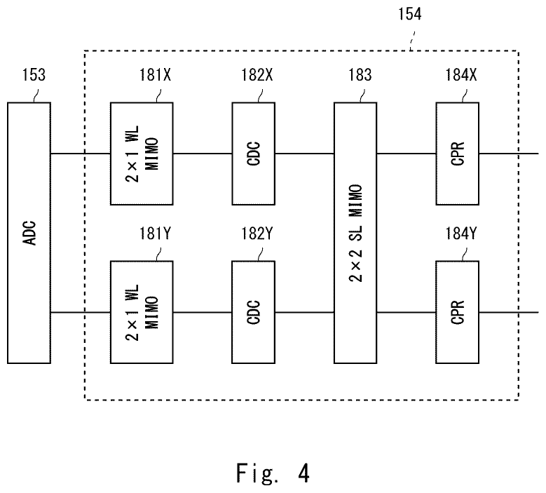

FIG. 4 illustrates a configuration example of the digital signal processing unit 154. The digital signal processing unit 154 includes 2×1 widely linear (WL) MIMO filters 181X and 181Y disposed for the X-polarized wave and the Y-polarized wave, chromatic dispersion compensation filters 182X and 182Y, and carrier phase compensation filters 184X and 184Y. The digital signal processing unit 154 includes a 2×2 strictly linear (SL) MIMO filter 183. In the present example embodiment, the MIMO filter is also referred to as a MIMO equalizer.

The X-polarization complex data and the Y-polarization complex data, which are output from the ADC 153 and obtained by respectively converting the I and Q components of the X-polarized wave and the I and Q components of the Y-polarized wave into complex signals, are input to the digital signal processing unit 154. In the digital signal processing unit 154, the 2×1 WL MIMO filters 181X and 181Y, the chromatic dispersion compensation filters 182X and 182Y, the 2×2 SL MIMO filter 183, and the carrier phase compensation filters 184X and 184Y are disposed to be connected in series to the input signal. These filters constitute an adaptive multilayer filter.

The 2×1 WL MIMO filters 181X and 181Y compensate for distortion occurring in the optical receiver 150, such as distortion occurring in the I component and the Q component in each polarization and crosstalk occurring between the I component and the Q component. The 2×1 WL MIMO filters 181X and 181Y correspond to the in-receiver distortion compensation filters. A 2×1 WL MIMO filter is equivalent to a 2×2 IQ MIMO filter for inputting and outputting the I component and the Q component, and the 2×2 IQ MIMO filter may be used to compensate for the distortion occurring in the optical receiver 150. A variation in the in-receiver distortion is moderate, and the variation in the in-receiver distortion is captured as a quasi-dynamic variation. In the present example embodiment, the 2×1 WL MIMO filters 181X and 181Y are treated as quasi-static filters.

The chromatic dispersion compensation filters 182X and 182Y compensate for the signal distortion caused by chromatic dispersion during optical fiber transmission for each polarized wave. The chromatic dispersion compensation filters 182X and 182Y are also referred to as chromatic dispersion compensation (CDC) filters. The coefficients of the chromatic dispersion compensation filters 182X and 182Y are set based on a physical model for distortion caused by the chromatic dispersion. The distortion caused by the chromatic dispersion is fixed, and the chromatic dispersion compensation filters 182X and 182Y are treated as static filters.

The 2×2 SL MIMO filter 183 is configured as a complex-coefficient MIMO filter having two complex-signal inputs and two complex-signal outputs. The 2×2 SL MIMO filter 183 compensates for the signal distortion caused by polarization state variation and polarization mode dispersion during optical fiber transmission. The carrier phase compensation filters 184X and 184Y compensate for the signal distortion caused by the frequency offset and the phase offset between the carrier of the transmitted optical signal and the receiver-side local oscillator light. For the carrier phase compensation filters 184X and 184Y, for example, SL 1×1 one-tap Finite Impulse Response (FIR) filters are used. The carrier phase compensation filters 184X and 184Y are also referred to as carrier phase recovery (CPR) filters.

The coefficients of the 2×2 SL MIMO filter 183 are adaptively updated using a coefficient update unit (not illustrated in FIG. 4). More specifically, the coefficient update unit calculates, as a loss function, a difference between the output of the carrier phase compensation filters 184X and 184Y, which are filters at the final stage of the adaptive multilayer filter, and a predetermined value or a desired state. The coefficient update unit updates the coefficients of the 2×2 SL MIMO filter 183 in such a way as to minimize the loss function. The phase compensated for by a carrier phase compensation filter 174 is separately calculated by a method (not illustrated) based on the output. A general M-th power method or a digital phase locked loop (PLL) using tentative determination can be used to calculate the phase to be compensated for.

In the digital signal processing unit 154, the 2×1 WL MIMO filters 181X and 181Y, the chromatic dispersion compensation filters 182X and 182Y, the 2×2 SL MIMO filter 183, and the carrier phase compensation filters 184X and 184Y can each be configured using a hardware circuit. On the other hand, the function of the coefficient update unit can be implemented by a processor included in the digital signal processing unit 154 operating in accordance with a program read from a memory.

Returning to FIG. 3, the digital signal output from the ADC 153 is input to the distortion estimation unit 160. In other words, a signal equivalent to the signal input to the digital signal processing unit 154 is branched to the distortion estimation unit 160. The distortion estimation unit 160 estimates in-transmitter distortion that is distortion occurring in the optical transmitter 110, and in-receiver distortion that is distortion occurring in the optical receiver 150, using the input digital signal. The distortion estimation unit 160 estimates the in-transmitter distortion and the in-receiver distortion, for example, at the time of factory shipment of the optical transmitter 110 and the optical receiver 150 or at the time of a test before operation of the optical fiber communication system 100. The distortion estimation unit 160 may estimate the in-transmitter distortion and the in-receiver distortion not constantly but intermittently during the operation of the optical fiber communication system 100.

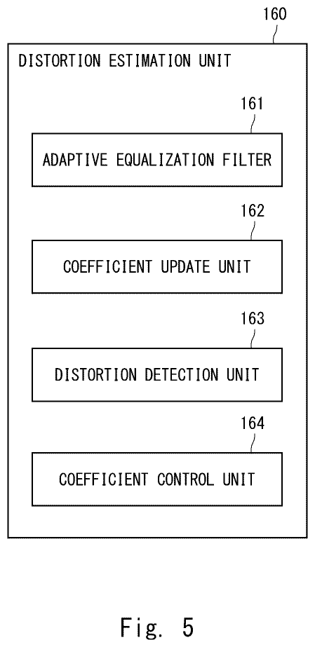

FIG. 5 illustrates a configuration example of the distortion estimation unit 160. The distortion estimation unit 160 includes an adaptive equalization filter 161, a coefficient update unit 162, a distortion detection unit 163, and a coefficient control unit 164. The distortion estimation unit 160 includes, for example, one or more processors and one or more memories. At least some of the functions of the distortion estimation unit 160 may be implemented by the processor operating in accordance with a program read from the memory. The distortion estimation unit 160 corresponds to the distortion estimation device 30 illustrated in FIG. 2.

The adaptive equalization filter 161 performs equalization processing on the digital signal output from the ADC 153. In the equalization processing, the adaptive equalization filter 161 compensates for various types of distortion included in the reception signal, including in-transmitter distortion and in-receiver distortion. The coefficient update unit 162 adaptively controls the coefficients of the adaptive equalization filter 161. The coefficient update unit 162 adaptively controls or updates the coefficients of the adaptive equalization filter 161 based on, for example, a difference between the output signal of the adaptive equalization filter 161 and a predetermined value or a desired state of the output signal. The adaptive equalization filter 161 corresponds to the equalization filter 31 illustrated in FIG. 2. The coefficient update unit 162 corresponds to the coefficient update unit 32 illustrated in FIG. 2.

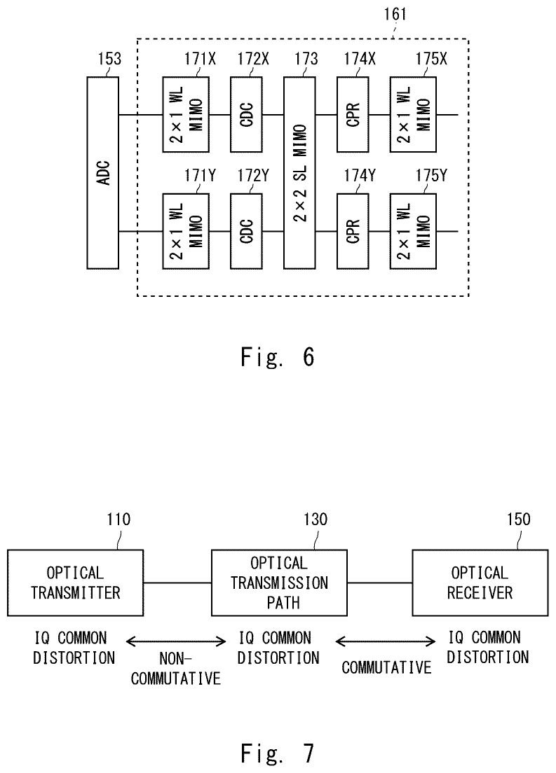

FIG. 6 illustrates a configuration example of the adaptive equalization filter 161. The X-polarization complex data and the Y-polarization complex data, which are output from the ADC 153 and obtained by respectively converting the I and Q components of the X-polarized wave and the I and Q components of the Y-polarized wave into complex signals, are input to the adaptive equalization filter 161. The adaptive equalization filter 161 includes 2×1 WL MIMO filters 171X and 171Y, chromatic dispersion compensation filters 172X and 172Y, a 2×2 SL MIMO filter 173, carrier phase compensation filters 174X and 174Y, and 2×1 WL MIMO filters 175X and 175Y. In the adaptive equalization filter 161, these filters are connected in series to the input signal.

The 2×1 WL MIMO filters 171X and 171Y compensate for distortion caused in the optical receiver 150 for each polarized wave. The chromatic dispersion compensation filters 172X and 172Y compensate for the signal distortion caused by chromatic dispersion during optical fiber transmission for each polarized wave. The 2×2 SL MIMO filter 172 is configured as a complex-coefficient MIMO filter having two complex-signal inputs and two complex-signal outputs. For the 2×2 SL MIMO filter 173, an FIR filter having a number of taps more than one is used. The 2×2 SL MIMO filter 172 compensates for the signal distortion caused by polarization state variation and polarization mode dispersion during optical fiber transmission. The 2×1 WL MIMO filters 171X and 171Y correspond to the in-receiver distortion compensation filter 35 illustrated in FIG. 2. The 2×2 SL MIMO filter 172 corresponds to the transmission path distortion compensation filter 36 illustrated in FIG. 2.

The carrier phase compensation filters 174X and 174Y compensate for the signal distortion caused by the frequency offset and the phase offset between the carrier of the transmitted optical signal and the receiver-side local oscillator light. For the carrier phase compensation filters 174X and 174Y, for example, SL 1×1 one-tap FIR filters are used. The 2×1 WL MIMO filters 175X and 175Y compensate for distortion caused in the optical transmitter 110 for each polarized wave. The 2×1 WL MIMO filters 175X and 175Y correspond to the in-transmitter distortion compensation filter 37 illustrated in FIG. 2.

The coefficient update unit 162 adaptively updates the coefficients of some filters included in the adaptive equalization filter 161 based on a difference between the output of the 2×1 WL MIMO filters 175X and 175Y and the desired state. In the present example embodiment, the coefficient update unit 162 adaptively updates the coefficients of the 2×1 WL MIMO filters 171X and 171Y, the 2×2 SL MIMO filter 173, and the 2×1 WL MIMO filters 175X and 175Y.

The coefficient update unit 162 calculates, for example, a difference between the output of the 2×1 WL MIMO filters 175X and 175Y and the desired state as a loss function. The coefficient update unit adaptively updates the coefficients of the 2×1 WL MIMO filters 171X and 171Y, the 2×2 SL MIMO filter 173, and the 2×1 WL MIMO filters 175X and 175Y in such a way as to minimize the loss function. The chromatic dispersion compensation filters 172X and 172Y are static filters with fixed coefficients. The phases compensated for by the carrier phase compensation filters 174X and 174Y are separately calculated using a general M-th power method or a digital PLL using tentative determination.

The distortion detection unit 163 detects or estimates the in-receiver distortion based on the coefficients of the 2×1 WL MIMO filters 171X and 171Y that compensate for the in-receiver distortion. The distortion detection unit 163 detects or estimates the in-transmitter distortion based on the coefficients of the 2×1 WL MIMO filters 175X and 175Y that compensate for the in-transmitter distortion. The distortion detection unit 163 can estimate each of the in-receiver distortion and the in-transmitter distortion by using a known algorithm for estimating distortion to be compensated for using the filter coefficient. The distortion detection unit 163 corresponds to the distortion detection unit 33 illustrated in FIG. 2.

FIG. 7 illustrates a relationship among distortions that occur in the optical transmitter 110, the transmission path 130, and the optical receiver 150. In the optical fiber communication system 100, distortion occurs in each of the optical transmitter 110, the transmission path 130, and the optical receiver 150. In a case where the nonlinear distortion is not applied to the transmission signal in the optical transmitter 110, the IQ common distortion occurring in the optical transmitter 110 and the IQ common distortion occurring in the transmission path 130 are commutative. The IQ common distortion occurring in the transmission path 130 is commutative with the IQ common distortion occurring in the optical receiver 150. Therefore, in the optical receiver 150, it is difficult to separate the IQ common distortion occurring in the optical transmitter 110 and the IQ common distortion occurring in the optical receiver 150 with high accuracy.

In the present example embodiment, the nonlinear distortion application unit 116 disposed in the optical transmitter 110 causes nonlinear distortion in the transmission signal in a case where the in-transmitter distortion and the in-receiver distortion are estimated by the distortion estimation unit 160. In this case, as illustrated in FIG. 7, the IQ common distortion occurring in the optical transmitter 110 is non-commutative with the IQ common distortion occurring in the transmission path 130. Therefore, it is possible to separate the IQ common distortion occurring in the optical transmitter 110 and the IQ common distortion occurring in the optical receiver 150. In the present example embodiment, the distortion estimation unit 160 estimates the in-transmitter distortion and the in-receiver distortion using the signal to which nonlinear distortion is applied on a transmitter-side. Therefore, the distortion estimation unit 160 can estimate the in-transmitter distortion and the in-receiver distortion with high accuracy.

Returning to FIG. 6, the coefficient control unit 164 sets or controls filter coefficients to compensate for the in-receiver distortion included in the digital signal processing unit 154 based on the in-receiver distortion estimated by the distortion detection unit 163. That is, the coefficient control unit 164 sets or controls the coefficients of the 2×1 WL MIMO filters 181X and 181Y (see FIG. 4) based on the estimated in-receiver distortion. For example, the coefficient control unit 164 controls the coefficients of the 2×1 WL MIMO filters 181X and 181Y in such a way as to compensate for the in-receiver distortion estimated by the distortion detection unit 163.

The coefficient control unit 164 sets or controls the coefficients of the pre-equalization unit 112 (see FIG. 3) included in the optical transmitter 110 based on the in-transmitter distortion estimated by the distortion detection unit 163. The coefficient control unit 164 controls the coefficients of the pre-equalization unit 112 in such a way that for example, characteristics of an inverse characteristic for in-transmitter distortion estimated by the distortion detection unit 163 are added to a signal to be output to the DAC 113. By controlling the filter coefficients of the pre-equalization unit 112 in accordance with the in-transmitter distortion estimated on the receiver side, it is possible to receive a signal in which the in-transmitter distortion is compensated for on the receiver side.

Variations in the in-transmitter distortion and the in-receiver distortion are moderate, and these variations are treated as a quasi-dynamic variation. Therefore, the coefficient control unit 164 does not need to control the coefficients of the 2×1 WL MIMO filters 181X and 181Y and control the coefficients of the pre-equalization unit 112 at all times, for example, for each symbol. In the present example embodiment, since the compensation for the in-transmitter distortion and the in-receiver distortion is performed on the quasi-dynamic variation, the adaptive equalization filter 161 in the distortion estimation unit 160 does not need to be implemented by a hardware circuit that operates at a high speed. In the present example embodiment, the adaptive equalization filter 161 is implemented by software processing. In other words, the adaptive equalization processing used for distortion estimation is offloaded to the software processing. In a case where the estimation of the in-transmitter distortion and the estimation of the in-receiver distortion are performed using the adaptive equalization filter 161 implemented by software processing, there is an effect of suppressing an increase in the hardware circuit of the digital signal processing unit 154.

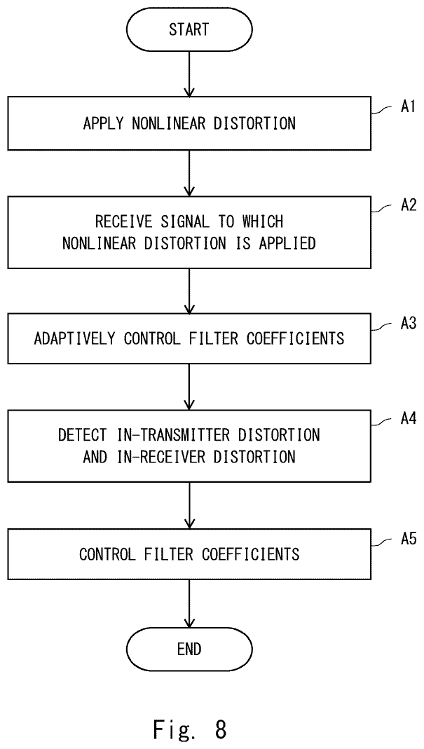

Next, an operation procedure will be described. FIG. 8 illustrates an operation procedure of distortion estimation in the optical fiber communication system 100. The operation procedure of distortion estimation corresponds to a distortion estimation method. In the optical transmitter 110, the nonlinear distortion application unit 116 applies nonlinear distortion to a signal transmitted from the optical transmitter 110 (step A1). The optical receiver 150 receives the optical signal to which the nonlinear distortion is applied on the transmitter side via the transmission path 130 (step A2).

In the optical receiver 150, complex data of each polarized wave to which nonlinear distortion is applied from the ADC 153 is input to the adaptive equalization filter 161 (see FIG. 5) of the distortion estimation unit 160. The coefficient update unit 162 adaptively controls the coefficients of the adaptive equalization filter 161 (step A3). In step A3, the coefficient update unit 162 adaptively updates the coefficients of the 2×1 WL MIMO filters 171X and 171Y, the 2×2 SL MIMO filter 173, and the 2×1 WL MIMO filters 175X and 175Y.

After convergence of the coefficients of the adaptive equalization filter 161, the distortion detection unit 163 detects the in-transmitter distortion and the in-receiver distortion based on the coefficients of the adaptive equalization filter 161 (step A4). In step A4, the distortion detection unit 163 detects the in-receiver distortion from the adaptively updated coefficients of the 2×1 WL MIMO filters 171X and 171Y. The distortion detection unit 163 detects the in-transmitter distortion from the adaptively updated coefficients of the 2×1 WL MIMO filters 175X and 175Y. The nonlinear distortion application unit 116 may stop applying the nonlinear distortion after the convergence of the coefficients of the adaptive equalization filter 161.

Based on the in-transmitter distortion and the in-receiver distortion detected in step A4, the coefficient control unit 164 controls filter coefficients to compensate for the in-transmitter distortion and filter coefficients to compensate for the in-receiver distortion (step A5). In step A5, the coefficient control unit 164 controls the coefficients of the 2×1 WL MIMO filters 181X and 181Y (see FIG. 4) included in the digital signal processing unit 154 in accordance with the detected in-receiver distortion. The coefficient control unit 164 controls the coefficients of the pre-equalization unit 112 included in the optical transmitter 110 based on the detected in-transmitter distortion.

In the present example embodiment, the nonlinear distortion application unit 116 applies nonlinear distortion to a signal in the optical transmitter 110. The distortion estimation unit 160 operates the adaptive equalization filter 161 and the coefficient update unit 162 using the complex signal of each polarized wave branched from the ADC 153. The distortion that can be compensated for in the adaptive equalization filter 161 having the configuration illustrated in FIG. 6 is limited to linear distortion, and the nonlinear distortion cannot be compensated for in the adaptive equalization filter 161. In a case where the nonlinear distortion occurs in the input signal of the adaptive equalization filter 161, the commutativity of the distortion is lost, and the in-transmitter distortion and the in-receiver distortion are non-commutative.

In the present example embodiment, the coefficient update unit 162 adaptively controls the filter coefficients to compensate for the in-transmitter distortion and the filter coefficients to compensate for the in-receiver distortion, which are included in the adaptive equalization filter 161, using a signal that causes nonlinear degradation in the optical transmitter 110. After convergence of the coefficients of the adaptive equalization filter 161, the distortion detection unit 163 detects the in-transmitter distortion and the in-receiver distortion. In the present example embodiment, in a case where the nonlinear distortion is applied to the signal in the optical transmitter 110, the IQ common distortion occurring in the optical transmitter 110 and the IQ common distortion occurring in the optical receiver 150 are non-commutative. Therefore, in the present example embodiment, the IQ common distortion occurring in the optical transmitter 110 and the IQ common distortion occurring in the optical receiver 150 can be separated with high accuracy, and as a result, the in-transmitter distortion and the in-receiver distortion can be estimated with high accuracy.

In the present example embodiment, the coefficient control unit 164 controls the coefficients of the pre-equalization unit 112 and the filter coefficients to compensate for the in-receiver distortion included in the digital signal processing unit 154 based on the estimated in-transmitter distortion and in-receiver distortion. In the present example embodiment, as described above, the in-transmitter distortion and the in-receiver distortion can be estimated with high accuracy. Therefore, in the present example embodiment, a signal in which the in-transmitter distortion and the in-receiver distortion are compensated for with high accuracy can be input to the decoding unit 155.

Next, a second example embodiment of the present disclosure will be described. A configuration of a communication system according to a second example embodiment of the present disclosure may be similar to the configuration of the optical fiber communication system 100 described in the first example embodiment illustrated in FIG. 3. In the present example embodiment, the configuration of the adaptive equalization filter 161 (see FIG. 5) in the distortion estimation unit 160 is different from the configuration of the adaptive equalization filter 161 described in the first example embodiment.

In the first example embodiment, the adaptive equalization filter 161 includes the 2×2 SL MIMO filter 173 as illustrated in FIG. 6. For the 2×2 SL MIMO filter 173, a multi-tap filter is used to compensate for polarization mode dispersion (PMD). The 2×2 SL MIMO filter 173 collectively adaptively compensates for transmission path distortion including the PMD. Therefore, the 2×2 SL MIMO filter 173 collectively compensates for not only the transmission path distortion but also the IQ common distortions of the optical transmitter 110 and the optical receiver 150 that can be commutative with the transmission path distortion.

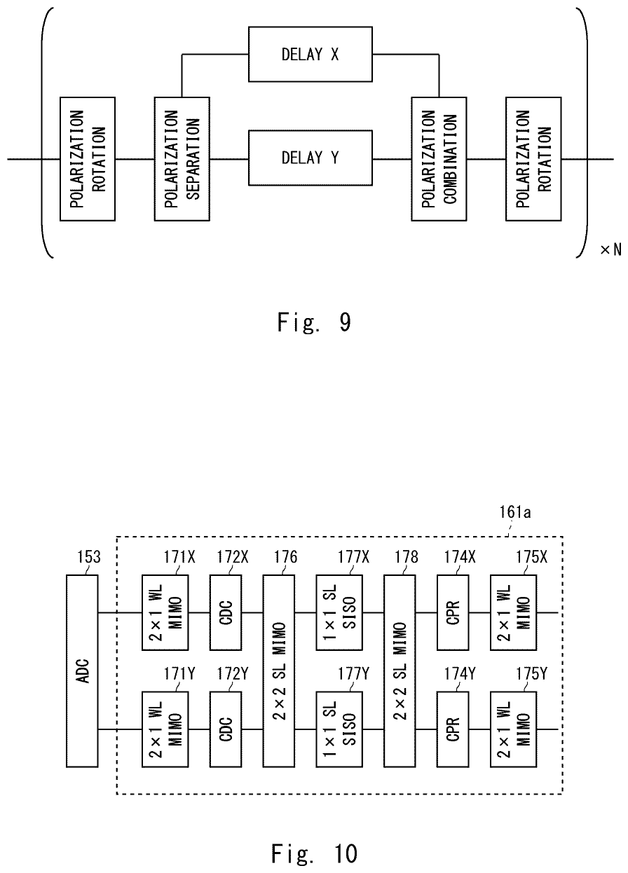

FIG. 9 illustrates a model of PMD in the transmission path 130. In the PMD, dominant first-order polarization mode dispersion (differential group delay: DGD) is considered as a penalty. The DGD is a delay between polarizations, and the DGD in the transmission path 130 can be modeled as illustrated in FIG. 9 by combining polarization rotation and a delay for each polarization. In the model illustrated in FIG. 9, N represents an integer equal to or more than two. The DGD can be compensated for simultaneously with polarization rotation by using a multi-tap 2×2 MIMO equalizer, but can be compensated for by using an equalizer having a filter configuration related to the model illustrated in FIG. 9.

FIG. 10 illustrates a configuration example of the adaptive equalization filter used in the present example embodiment. An adaptive equalization filter 161a to be used in the present example embodiment is different from the adaptive equalization filter 161 used in the first example embodiment in a filter configuration of a part that compensates for the transmission path distortion. In the adaptive equalization filter 161 illustrated in FIG. 6, the 2×2 SL MIMO filter 173 is used as a filter for transmission path distortion compensation. On the other hand, in the adaptive equalization filter 161 of the present example embodiment, a 2×2 SL MIMO filter 176, 1×1 SL single-input-single-output (SISO) filters 177X and 177Y, and a 2×2 SL MIMO filter 178 are used as filters that compensate for transmission path distortion.

In the present example embodiment, the 2×2 SL MIMO filters 176 and 178 are one-tap MIMO filters. The one-tap 2×2 SL MIMO filter 176 is related to polarization rotation and polarization separation of the model illustrated in FIG. 9. The one-tap 2×2 SL MIMO filter 178 is related to polarization combination and polarization rotation of the model illustrated in FIG. 9. The 1×1 SL SISO filters 177X and 177Y are related to a delay X and a delay Y in the model illustrated in FIG. 9.

FIG. 11 illustrates a more detailed configuration of the filter configuration of a part that compensates for transmission path distortion in the adaptive equalization filter 161a. The 2×2 SL MIMO filter 176 has four one-tap filters with coefficients h1_{XX}, h1_{YX}, h1_{XY}, and h1_{YY}. The 1×1 SL SISO filters 177X and 177Y are configured as filters that compensate for only a delay for each polarization. The delay in the transmission path is calculated by an arbitrary method. The 2×2 SL MIMO filter 178 has four one-tap filters with coefficients h2_{XX}, h2_{YX}, h2_{XY}, and h2_{YY}.

The one-tap 2×2 SL MIMO filters 176 and 178 cannot compensate for frequency-dependent distortion. In a case where the restriction to compensate for only the delay is applied to the 1×1 SL SISO filters 177X and 177Y, the 1×1 SL SISO filters 177X and 177Y do not compensate for the frequency-dependent distortion. In a case where a multi-tap MIMO equalizer is used to compensate for the transmission path distortion, the common distortion between the transmitter and the receiver may be overcompensated as described above. In the present example embodiment, by employing the above-described configuration in a part that compensates for the transmission path distortion instead of the multi-tap MIMO equalizer, it is possible to avoid the overcompensation of the common distortion between the transmitter and the receiver in the adaptive equalization filter 161a.

In the above description, an example has been described in which the adaptive equalization filter 161a includes the 2×2 SL MIMO filter 176, the 1×1 SL SISO filters 177X and 177Y, and the 2×2 SL MIMO filter 178. However, in the present example embodiment, the configuration of the adaptive equalization filter 161a is not limited to the configuration described above.

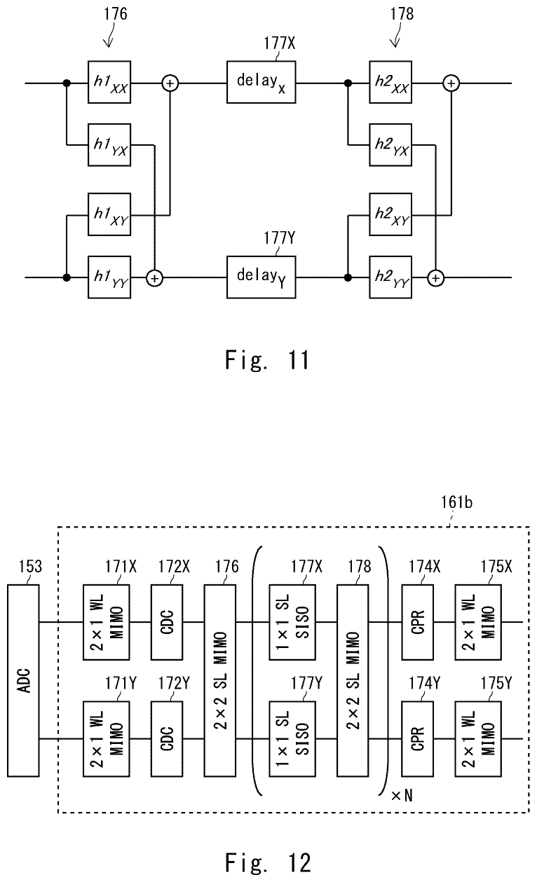

FIG. 12 illustrates a modified example of the adaptive equalization filter used in the distortion estimation unit 160. In this example, an adaptive equalization filter 161b includes N sets of the 1×1 SL SISO filters 177X and 177Y and the 2×2 SL MIMO filter 178. In this case, N sets of delays and polarization rotations in the model of the transmission path illustrated in FIG. 9 are compensated for by N sets of the 1×1 SL SISO filters 177X and 177Y and the 2×2 SL MIMO filter 178. In a case where the adaptive equalization filter 161b having such a configuration is used, the DGD in the transmission path can be compensated for with a filter configuration closer to the model of the transmission path.

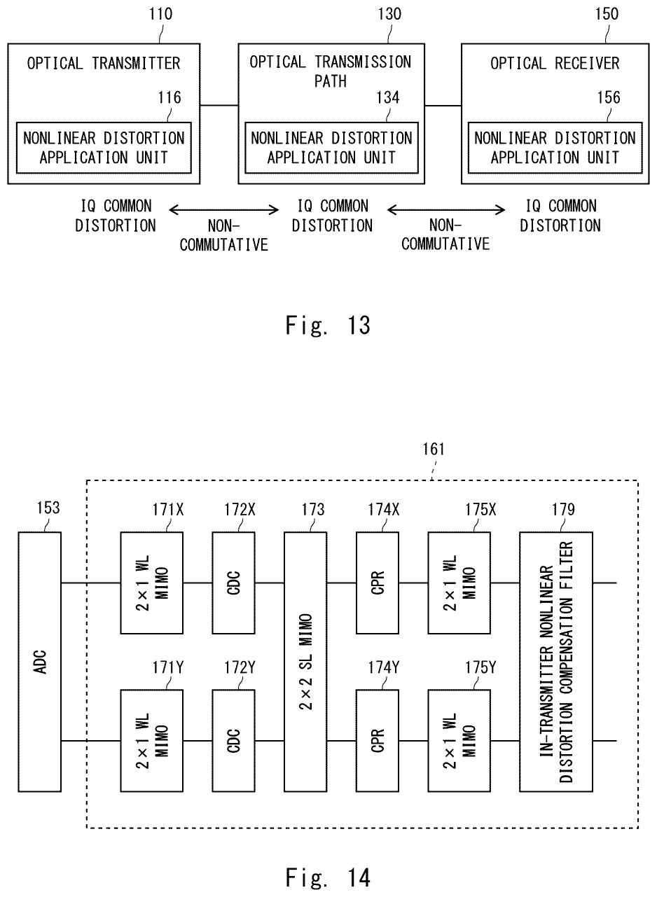

Next, a third example embodiment of the present disclosure will be described. FIG. 13 illustrates a communication system according to the third example embodiment of the present disclosure. In the optical fiber communication system according to the present example embodiment, the transmission path 130 includes a nonlinear distortion application unit 134 in addition to the components of the transmission path illustrated in FIG. 3. The optical receiver 150 includes a nonlinear distortion application unit 156 in addition to the components of the optical receiver illustrated in FIG. 3.

The nonlinear distortion application unit 134 of the transmission path 130 causes nonlinear distortion in a signal transmitted from the optical transmitter 110 toward the optical receiver 150. The nonlinear distortion application unit 134 applies the nonlinear distortion to the signal to be transmitted, for example, by increasing a signal input level to the optical fiber 132 and causing an optical Kerr effect.

The nonlinear distortion application unit 156 of the optical receiver 150 causes nonlinear distortion of the signal input to the distortion estimation unit 160 in the optical receiver 150. The nonlinear distortion application unit 156 may cause the nonlinear distortion in the signal, for example, by saturating the input level of the electrical amplifier disposed between the coherent receiver 152 and the ADC 153. Alternatively, the nonlinear distortion application unit 156 may cause the nonlinear distortion in the signal by saturating the gain of the electrical amplifier. The nonlinear distortion application unit 156 may cause the nonlinear distortion in the signal by saturating the input level of the ADC 153.

In the first example embodiment, the distortion estimation unit 160 of the optical receiver 150 receives the signal to which the nonlinear distortion is applied in the optical transmitter 110. In the present example embodiment, the distortion estimation unit 160 receives the signal to which the nonlinear distortion is applied in at least one of the optical transmitter 110, the transmission path 130, or the optical receiver 150. For example, in a case where the nonlinear distortion is applied to the signal at two locations of the optical transmitter 110 and the transmission path 130, the IQ common distortion in the optical receiver 150 is non-commutative with both the IQ common distortion in the optical transmitter 110 and the IQ common distortion in the transmission path 130. In this case, in the estimation of the distortion, the IQ common distortion in the transmission path and the IQ common distortion in the receiver can be accurately separated. In this case, the in-receiver distortion can be estimated with high accuracy, and the coefficients of the 2×1 WL MIMO filters 181X and 181Y (see FIG. 4) of the digital signal processing unit 154 can be controlled in accordance with the in-receiver distortion estimated with high accuracy.

A fourth example embodiment of the present disclosure will be described. FIG. 14 illustrates a configuration example of the adaptive equalization filter of the distortion estimation unit 160 used in the fourth example embodiment of the present disclosure. In the present example embodiment, an adaptive equalization filter 161c includes an in-transmitter nonlinear distortion compensation filter 179 in addition to the configuration of the adaptive equalization filter 161 illustrated in FIG. 6. The adaptive equalization filter 161c may include the in-transmitter nonlinear distortion compensation filter 179 in addition to the configuration of the adaptive equalization filter 161a illustrated in FIG. 10 or the configuration of the adaptive equalization filter 161b illustrated in FIG. 12.

The in-transmitter nonlinear distortion compensation filter 179 is disposed at a subsequent stage of the 2×1 WL MIMO filters 175X and 175Y that compensate for in-transmitter distortion in the adaptive equalization filter 161c. The in-transmitter nonlinear distortion compensation filter 179 includes a nonlinear filter for each polarization. The nonlinear filter includes a deep neural network (DNN), a convolutional neural network (CNN), or a Volterra filter. The nonlinear filter compensates for nonlinear distortion occurring in the transmitter for each of the I and Q components. In the present example embodiment, the coefficient update unit 162 adaptively controls the filter coefficients of the adaptive equalization filter 161c using the output signal of the in-transmitter nonlinear distortion compensation filter 179.

In a case where the nonlinear distortion is applied in a transmitter-side device, the signal quality may be degraded on the receiver side due to the nonlinear degradation, and the accuracy of the filter coefficients that compensate for the in-transmitter distortion may be degraded. In the present example embodiment, in the adaptive equalization filter 161c, the in-transmitter nonlinear distortion compensation filter 179 can compensate for the nonlinear distortion applied by the nonlinear distortion application unit 116. Therefore, in the adaptive control of the coefficients of the adaptive equalization filter 161c, the filter coefficients to compensate for the in-transmitter distortion can be appropriately controlled. As a result, the in-transmitter distortion can be accurately estimated.

A fifth example embodiment of the present disclosure will be described. The fifth example embodiment of the present disclosure is an example embodiment for measuring the quality of the reception signal and controlling the filter coefficients to compensate for the in-receiver distortion and the filter coefficients to compensate for the in-transmitter distortion in accordance with the measured quality in any one of the first to fourth example embodiments or a combination thereof.

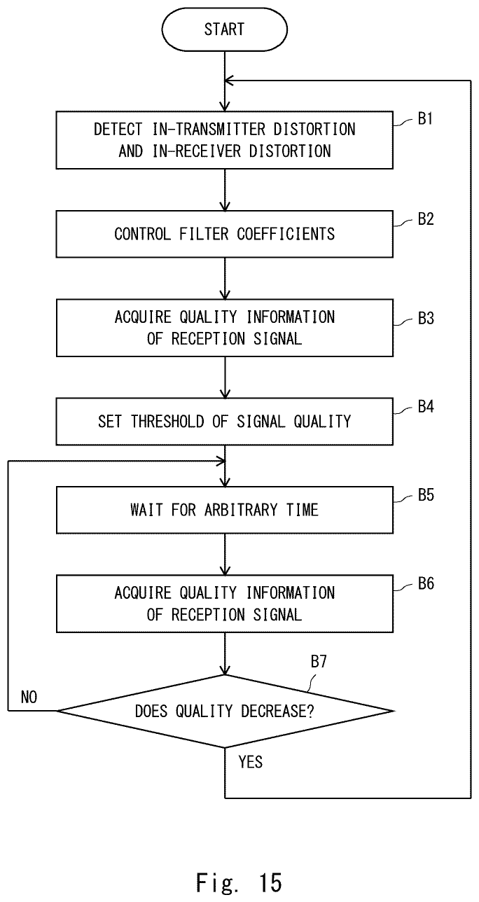

FIG. 15 illustrates an operation procedure of filter coefficient control in the present example embodiment. In the optical transmitter 110, the nonlinear distortion application unit 116 applies the nonlinear distortion to the signal transmitted from the optical transmitter 110. In the optical receiver 150, the coefficient update unit 162 of the distortion estimation unit 160 adaptively controls the coefficients of the adaptive equalization filter 161. After convergence of the coefficients of the adaptive equalization filter 161, the distortion detection unit 163 detects the in-transmitter distortion and the in-receiver distortion based on the coefficients of the adaptive equalization filter 161 (step B1). Based on the in-transmitter distortion and the in-receiver distortion detected in step B1, the coefficient control unit 164 controls the filter coefficients to compensate for the in-transmitter distortion and the filter coefficients to compensate for the in-receiver distortion (step B2). The operations in steps B1 and B2 may be similar to the operations in steps Al to A5 illustrated in FIG. 8.

After performing step B2, the distortion estimation unit 160 acquires quality information of the reception signal (step B3). For example, the distortion estimation unit 160 may acquire the number of error corrections from the error correction function included in the decoding unit 155, and calculate the quality information based on the acquired number of error corrections. The distortion estimation unit 160 sets or determines a threshold of the quality information based on the quality information acquired in step B3 (step B4). For example, the distortion estimation unit 160 may determine a quality obtained by adding an arbitrary offset value to the quality information acquired in step B3 as the threshold of the quality information. The threshold determined in step B4 is lower than the quality indicated by the quality information acquired in step B3.

The distortion estimation unit 160 waits for an arbitrary time (step B5). After that, the distortion estimation unit 160 acquires the quality information of the reception signal (step B6). The distortion estimation unit 160 compares the quality information acquired in step B6 with the threshold determined in step B4. In a case where it is determined that the quality indicated by the quality information acquired in step B6 decreases beyond the threshold determined in step B4, the distortion estimation unit 160 returns to step B1 and detects the in-transmitter distortion and the in-receiver distortion. In a case where the quality indicated by the quality information acquired in step B6 is within the threshold determined in step B4, the distortion estimation unit 160 determines that the quality is not degraded, returns to step B5, and waits for a predetermined time.

Thereafter, the quality information is acquired again in step B6, and it is determined whether the quality of the reception signal decreases.

In the present example embodiment, the distortion estimation unit 160 periodically acquires the quality of the reception signal. In a case where the quality of the reception signal decreases, the distortion detection unit 163 detects the in-transmitter distortion and the in-receiver distortion. The coefficient control unit 164 controls the coefficients of the pre-equalization unit 112 of the optical transmitter 110 and the coefficients of the 2×1 WL MIMO filters 181X and 181Y of the digital signal processing unit 154 in accordance with the detected in-transmitter distortion and in-receiver distortion. In such a way, in the present example embodiment, it is possible to suppress the degradation of the quality of the reception signal by a certain level or more.

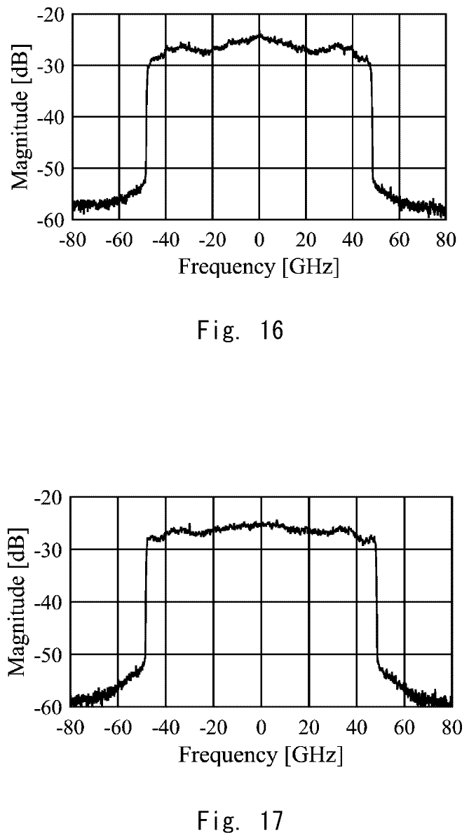

In order to confirm the effect of the above-described example embodiments, the present inventor has conducted an experiment. In the experiment, a 96-GBaud polarization-multiplexed 64-QAM signal is used. FIGS. 16 to 18 are spectrum diagrams illustrating an optical spectrum of a transmission signal measured in the experiment. In FIGS. 16 to 18, the horizontal axis represents frequency, and the vertical axis represents spectral intensity. In the experiment, the optical spectrum of the polarization-multiplexed optical signal in which the X-polarized wave and the Y-polarized wave output from the optical modulator 114 are multiplexed in the optical transmitter 110 is measured.

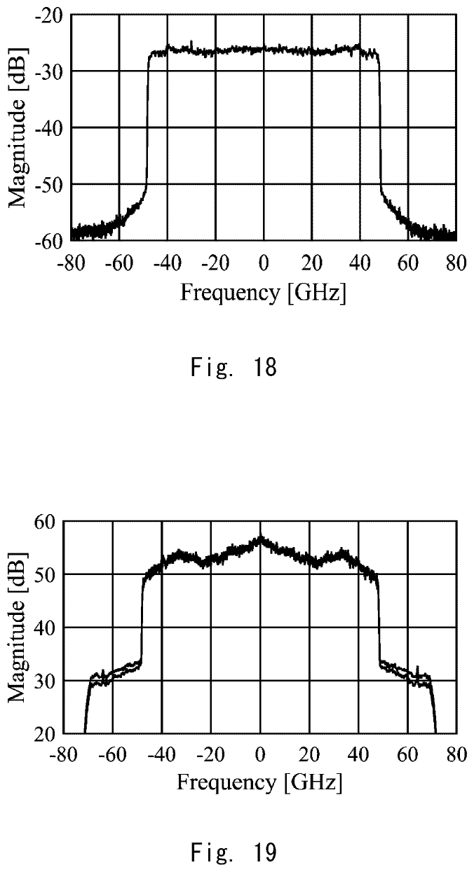

FIG. 16 illustrates an optical spectrum of a transmission signal in a case where the in-transmitter distortion and the in-receiver distortion are not compensated for in accordance with the detected distortion. FIG. 17 illustrates an optical spectrum of a transmission signal in a case where the 2×2 SL MIMO filter 173 with 17 taps is used in the adaptive equalization filter 161 illustrated in FIG. 6, described in the first example embodiment for distortion detection. FIG. 18 illustrates an optical spectrum of a transmission signal in a case where the adaptive equalization filter 161a illustrated in FIG. 10 described in the second example embodiment is used for distortion detection.

If the spectrum illustrated in FIG. 16 is compared with the spectrum illustrated in FIG. 17, it can be seen that the optical spectrum has a small variation with respect to the frequency changes in FIG. 17. If the spectrum illustrated in FIG. 17 is compared with the spectrum illustrated in FIG. 18, it can be seen that the optical spectrum has a smaller variation with respect to the frequency changes in FIG. 18. In the optical spectrum, small variation of spectral intensity with respect to frequency is more important than the spectral intensity itself. As a result of the experiment, it is confirmed that good signal characteristics are obtained by performing the distortion detection and the distortion compensation described in the above-described example embodiments.

FIGS. 19 to 21 are spectrum diagrams illustrating a spectrum of a reception signal measured in the experiment. In FIGS. 19 to 21, the horizontal axis represents frequency, and the vertical axis represents the intensity of the reception signal. In the experiment, the spectra of the output signals of the 2×1 WL MIMO filters 181X and 181Y of the digital signal processing unit 154 are measured for each polarized wave.

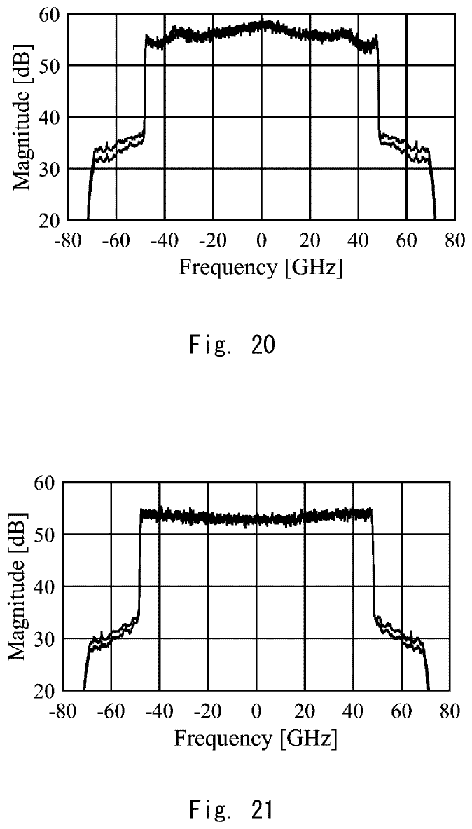

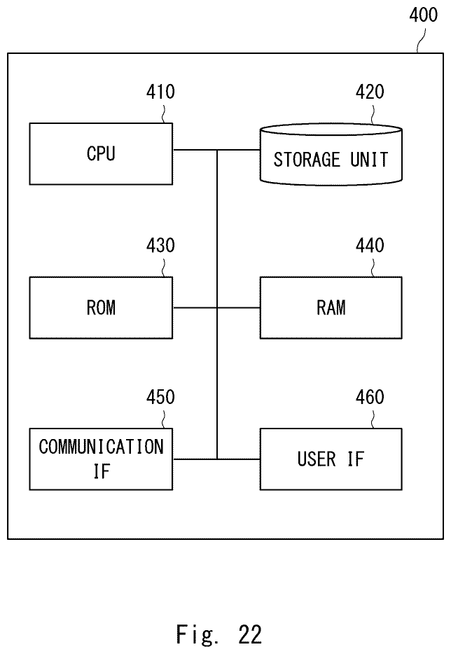

FIG. 19 illustrates the spectra of the reception signals of the X-polarized wave and the Y-polarized wave in a case where the in-transmitter distortion and the in-receiver distortion are not compensated for in accordance with the detected distortion. FIG. 20 illustrates spectra of the reception signals of the X-polarized wave and the Y-polarized wave in a case where the 2×2 SL MIMO filter 173 with 17 taps is used in the adaptive equalization filter 161 illustrated in FIG. 6, described in the first example embodiment for distortion detection. FIG. 21 illustrates spectra of the reception signals of the X-polarized wave and the Y-polarized wave in a case where the adaptive equalization filter 161a illustrated in FIG. 10 described in the second example embodiment is used for distortion detection.

If the spectrum illustrated in FIG. 19 is compared with the spectrum illustrated in FIG. 20, it can be seen that the spectrum of the reception signal for each polarized wave has a small variation with respect to the frequency changes in FIG. 20. If the spectrum illustrated in FIG. 20 is compared with the spectrum illustrated in FIG. 21, it can be seen that the spectrum has a smaller variation with respect to the frequency changes in FIG. 21. In the spectrum of the reception signal, it is important that the frequency change of the spectral intensity is smaller than the spectral intensity. As a result of the experiment, it is confirmed that good signal characteristics are obtained by performing the distortion detection and the distortion compensation described in the above-described example embodiments.

In each of the above-described example embodiments, an example in which the distortion estimation unit 160 is included in the optical receiver 150 has been described. However, the present disclosure is not limited thereto. The distortion estimation unit 160 may be configured as a device different from the optical receiver 150. In this case, the distortion estimation unit 160 may be configured as a computer device such as a personal computer (PC). For example, the optical receiver 150 may have an interface for connection with the computer device, and may output the digital signal output from the ADC 153 to the computer device through the interface.

FIG. 22 illustrates a configuration example of the computer device that can be used as the distortion estimation unit 160. A computer device 400 includes a central processing unit (CPU) 410, a storage unit 420, a read only memory (ROM) 430, a random access memory (RAM) 440, a communication interface (IF) 450, and a user interface 460.

The communication interface 450 is an interface used for communication with an external device. The communication interface 450 can be used to acquire four channels of reception signals output from the ADC 153. The user interface 460 includes, for example, a display unit such as a display. The user interface 460 includes input units such as a keyboard, a mouse, and a touch panel.

The storage unit 420 is an auxiliary storage device that can hold various types of data. The storage unit 420 is not necessarily a part of the computer device 400 and may be an external storage device or a cloud storage connected to the computer device 400 via a network.

The ROM 430 is a nonvolatile storage device. For example, a semiconductor storage device such as a flash memory with a relatively small capacity may be used as the ROM 430. A program executed by the CPU 410 can be stored in the storage unit 420 or the ROM 430. The storage unit 420 or the ROM 430 stores various programs for causing the CPU 410 to execute processing for performing distortion compensation and detection.

The program described above includes a group of instructions or software codes for causing a computer to perform one or more functions described in the example embodiments in a case where the program is read by the computer. The program may be stored in a non-transitory computer-readable medium or a tangible storage medium. As an example and not by way of limitation, the computer-readable medium or the tangible storage medium includes a RAM, a ROM, a flash memory, a solid-state drive (SSD) or any other memory technology, a compact disc (CD), a digital versatile disc (DVD), a Blu-ray (registered trademark) disc or any other optical disc storage, and a magnetic cassette, a magnetic tape, a magnetic disk storage, or any other magnetic storage device. The program may be transmitted on a transitory computer-readable medium or a communication medium. As an example and not by way of limitation, the transitory computer-readable medium or the communication medium includes an electric signal, an optical signal, an acoustic signal, or any other form of propagation signal.

The RAM 440 is a volatile storage device. As the RAM 440, various types of semiconductor memory devices such as a dynamic random access memory (DRAM) and a static random access memory (SRAM) are used. The RAM 440 can be used as an internal buffer for temporarily storing data or the like. The CPU 410 loads a program stored in the storage unit 420 or the ROM 430 into the RAM 440 and executes the loaded program. The CPU 410 may include an internal buffer that can temporarily store data or the like.

While example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

For example, some or all of the above-described example embodiments may be described as the following Supplementary Notes, but the present disclosure is not limited to the following Supplementary Notes.

### Supplementary Note 1

A distortion estimation device including:
an equalization filter that includes an in-receiver distortion compensation filter that compensates for in-receiver distortion occurring in a polarization-multiplexed signal in a receiver that receives the polarization-multiplexed signal transmitted from a transmitter via a transmission path, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter, and performs equalization processing on a signal to which nonlinear distortion is applied in at least one of the transmitter, the transmission path, or the receiver, the signal being received by the receiver;
a coefficient update unit that adaptively controls filter coefficients of the in-receiver distortion compensation filter, the transmission path distortion compensation filter, and the in-transmitter distortion compensation filter; and
a distortion detection unit that detects the in-receiver distortion based on the filter coefficients of the in-receiver distortion compensation filter, and detects the in-transmitter distortion based on the filter coefficients of the in-transmitter distortion compensation filter, after convergence of the filter coefficients.

### Supplementary Note 2

The distortion estimation device according to Supplementary Note 1, in which the transmission path distortion compensation filter includes a first polarization rotation compensation filter that compensates for polarization rotation, a delay compensation filter that compensates for a delay for each polarized wave, and a second polarization rotation compensation filter that compensates for polarization rotation.

### Supplementary Note 3

The distortion estimation device according to Supplementary Note 2, in which the transmission path distortion compensation filter includes a plurality of sets of the delay compensation filter and the second polarization rotation compensation filter.

### Supplementary Note 4

The distortion estimation device according to Supplementary Note 2, in which each of the first polarization rotation compensation filter and the second polarization rotation compensation filter is a one-tap 2×2 Multiple-Input and Multiple-Output (MIMO) equalizer.

### Supplementary Note 5

The distortion estimation device according to Supplementary Note 1, in which the transmission path distortion compensation filter includes a multi-tap 2×2 MIMO equalizer.

### Supplementary Note 6

The distortion estimation device according to any one of Supplementary Notes 1 to 5, in which
the transmitter includes a digital analog converter that converts a digital signal into an analog signal, an electrical amplifier that amplifies an output signal of the digital analog converter, and a modulator that modulates a signal in accordance with a signal amplified by the electrical amplifier, and
the nonlinear distortion is applied to the signal by at least one of saturating an output level of the digital analog converter, saturating an input level of the electrical amplifier, saturating a gain of the electrical amplifier, or saturating an input level of the modulator, in the transmitter.

### Supplementary Note 7

The distortion estimation device according to any one of Supplementary Notes 1 to 6, in which
the transmission path includes an optical fiber for transmitting the polarization-multiplexed signal, and
the nonlinear distortion is applied to the signal by causing the optical fiber in the transmission path to have an optical Kerr effect.

### Supplementary Note 8

The distortion estimation device according to any one of Supplementary Notes 1 to 7, in which
the receiver includes a detector that coherently receives the polarization-multiplexed signal, an electrical amplifier that amplifies an analog signal output from the detector, and an analog digital converter that converts the analog signal amplified by the electrical amplifier into a digital signal, and
the nonlinear distortion is applied to the signal by at least one of saturating an input level of the electrical amplifier, saturating a gain of the electrical amplifier, or saturating an input level of the analog digital converter, in the receiver.

### Supplementary Note 9

The distortion estimation device according to any one of Supplementary Notes 1 to 8, in which
the receiver includes an equalization signal processing circuit including the in-receiver distortion compensation filter that compensates for the in-receiver distortion occurring in the receiver, and
the distortion estimation device further includes a coefficient control unit that controls coefficients of the in-receiver distortion compensation filter of the equalization signal processing circuit in accordance with the detected in-receiver distortion.

### Supplementary Note 10

The distortion estimation device according to Supplementary Note 9, in which
the transmitter includes a pre-equalization filter that pre-equalizes a polarization-multiplexed signal to be output to the transmission path, and
the coefficient control unit controls coefficients of the pre-equalization filter in accordance with the detected in-transmitter distortion.

### Supplementary Note 11

The distortion estimation device according to any one of Supplementary Notes 1 to 10, in which the equalization filter further includes a carrier phase compensation filter and a chromatic dispersion compensation filter.

### Supplementary Note 12

A receiver including:
a detector that coherently receives a polarization-multiplexed signal transmitted from a transmitter via a transmission path; and
a distortion estimation device that detects distortion included in a signal based on the coherently received polarization-multiplexed signal,
in which the distortion estimation device includes
an equalization filter that includes an in-receiver distortion compensation filter that compensates for in-receiver distortion occurring in the polarization-multiplexed signal in the receiver, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter, and performs equalization processing on a signal to which nonlinear distortion is applied in at least one of the transmitter, the transmission path, or the receiver, the signal being received by the receiver,
a coefficient update unit that adaptively controls filter coefficients of the in-receiver distortion compensation filter, the transmission path distortion compensation filter, and the in-transmitter distortion compensation filter, and
a distortion detection unit that detects the in-receiver distortion based on the filter coefficients of the in-receiver distortion compensation filter, and detects the in-transmitter distortion based on the filter coefficients of the in-transmitter distortion compensation filter, after convergence of the filter coefficients.

### Supplementary Note 13

The receiver according to Supplementary Note 12, in which the transmission path distortion compensation filter includes a first polarization rotation compensation filter that compensates for polarization rotation, a delay compensation filter that compensates for a delay for each polarized wave, and a second polarization rotation compensation filter that compensates for polarization rotation.

### Supplementary Note 14

The receiver according to Supplementary Note 13, in which the transmission path distortion compensation filter includes a plurality of sets of the delay compensation filter and the second polarization rotation compensation filter.

### Supplementary Note 15

The receiver according to any one of Supplementary Notes 12 to 14, in which
the transmitter includes a digital analog converter that converts a digital signal into an analog signal, an electrical amplifier that amplifies an output signal of the digital analog converter, and a modulator that modulates a signal in accordance with a signal amplified by the electrical amplifier, and
the nonlinear distortion is applied to the signal by at least one of saturating an output level of the digital analog converter, saturating an input level of the electrical amplifier, saturating a gain of the electrical amplifier, or saturating an input level of the modulator, in the transmitter.

### Supplementary Note 16

The receiver according to any one of Supplementary Notes 12 to 15, in which
the receiver includes an equalization signal processing circuit including the in-receiver distortion compensation filter that compensates for the in-receiver distortion occurring in the receiver, and
the distortion estimation device further includes a coefficient control unit that controls coefficients of the in-receiver distortion compensation filter of the equalization signal processing circuit in accordance with the detected in-receiver distortion.

### Supplementary Note 17

A communication system including:
a transmitter that transmits a polarization-multiplexed signal;
a transmission path that transmits the polarization-multiplexed signal;
a receiver that receives the polarization-multiplexed signal via the transmission path; and
a distortion estimation device,
in which the distortion estimation device includes
an equalization filter that includes an in-receiver distortion compensation filter that compensates for in-receiver distortion occurring in the polarization-multiplexed signal in the receiver, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter, and performs equalization processing on a signal to which nonlinear distortion is applied in at least one of the transmitter, the transmission path, or the receiver, the signal being received by the receiver,
a coefficient update unit that adaptively controls filter coefficients of the in-receiver distortion compensation filter, the transmission path distortion compensation filter, and the in-transmitter distortion compensation filter, and
a distortion detection unit that detects the in-receiver distortion based on the filter coefficients of the in-receiver distortion compensation filter, and detects the in-transmitter distortion based on the filter coefficients of the in-transmitter distortion compensation filter, after convergence of the filter coefficients.

### Supplementary Note 18

The communication system according to Supplementary Note 17, in which the transmission path distortion compensation filter includes a first polarization rotation compensation filter that compensates for polarization rotation, a delay compensation filter that compensates for a delay for each polarized wave, and a second polarization rotation compensation filter that compensates for polarization rotation.

### Supplementary Note 19

The communication system according to Supplementary Note 18, in which the transmission path distortion compensation filter includes a plurality of sets of the delay compensation filter and the second polarization rotation compensation filter.

### Supplementary Note 20

The communication system according to any one of Supplementary Notes 17 to 19, in which at least one of the transmitter, the transmission path, or the receiver includes a nonlinear distortion application unit that causes nonlinear distortion in the signal.

### Supplementary Note 21

The communication system according to any one of Supplementary Notes 17 to 20, in which
the receiver includes an equalization signal processing circuit including the in-receiver distortion compensation filter that compensates for the in-receiver distortion occurring in the receiver, and
the distortion estimation device further includes a coefficient control unit that controls coefficients of the in-receiver distortion compensation filter of the equalization signal processing circuit in accordance with the detected in-receiver distortion.

### Supplementary Note 22

The communication system according to Supplementary Note 21, in which
the transmitter includes a pre-equalization filter that pre-equalizes a polarization-multiplexed signal to be output to the transmission path, and
the coefficient control unit controls coefficients of the pre-equalization filter in accordance with the detected in-transmitter distortion.

### Supplementary Note 23

A distortion estimation method including:
performing equalization processing on a signal to which nonlinear distortion is applied in at least one of a transmitter, a transmission path, or a receiver, the signal being received by the receiver, by using an equalization filter that includes an in-receiver distortion compensation filter that compensates for in-receiver distortion occurring in a polarization-multiplexed signal in the receiver that receives the polarization-multiplexed signal transmitted from the transmitter via the transmission path, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter;
adaptively controlling filter coefficients of the in-receiver distortion compensation filter, the transmission path distortion compensation filter, and the in-transmitter distortion compensation filter; and
detecting the in-receiver distortion based on the filter coefficients of the in-receiver distortion compensation filter, and detecting the in-transmitter distortion based on the filter coefficients of the in-transmitter distortion compensation filter, after convergence of the filter coefficients.

### Supplementary Note 24

The distortion estimation method according to Supplementary Note 23, in which
the receiver includes an equalization signal processing circuit including the in-receiver distortion compensation filter that compensates for the in-receiver distortion occurring in the receiver, and
the distortion estimation method further includes controlling coefficients of the in-receiver distortion compensation filter of the equalization signal processing circuit included in the receiver in accordance with the detected in-receiver distortion.

### Supplementary Note 25

The distortion estimation method according to Supplementary Note 24, in which
the transmitter includes a pre-equalization filter that pre-equalizes a polarization-multiplexed signal to be output to the transmission path, and
the distortion estimation method further includes controlling coefficients of the pre-equalization filter in accordance with the detected in-transmitter distortion.

### Supplementary Note 26

A non-transitory computer-readable medium storing a program for causing a processor to execute a process, the process including:
performing equalization processing on a signal to which nonlinear distortion is applied in at least one of a transmitter, a transmission path, or a receiver, the signal being received by the receiver, by using an equalization filter that includes an in-receiver distortion compensation filter that compensates for in-receiver distortion occurring in a polarization-multiplexed signal in the receiver that receives the polarization-multiplexed signal transmitted from the transmitter via the transmission path, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter;
adaptively controlling filter coefficients of the in-receiver distortion compensation filter, the transmission path distortion compensation filter, and the in-transmitter distortion compensation filter; and
detecting the in-receiver distortion based on the filter coefficients of the in-receiver distortion compensation filter, and detecting the in-transmitter distortion based on the filter coefficients of the in-transmitter distortion compensation filter, after convergence of the filter coefficients.

### REFERENCE SIGNS LIST

10 communication system
11 transmitter
13 transmission path
15 receiver
21 detector
30 distortion estimation device
31 equalization filter
32 coefficient update unit
33 distortion detection unit
35 in-receiver distortion compensation filter
36 transmission path distortion compensation filter
37 in-transmitter distortion compensation filter
100 optical fiber communication system
110 optical transmitter
111 encoding unit
112 pre-equalization unit
113 DAC
114 optical modulator
115 LD
116 nonlinear distortion application unit
130 transmission path
132 optical fiber
133 optical amplifier
134 nonlinear distortion application unit
150 optical receiver
151 LD
152 coherent receiver
153 ADC
154 digital signal processing unit
155 decoding unit
156 nonlinear distortion application unit
160 distortion estimation unit
161 adaptive equalization filter
162 coefficient update unit
163 distortion detection unit
164 coefficient control unit
171X, 171Y 2×1 WL MIMO filter
172X, 172Y chromatic dispersion compensation filter
173 2×2 SL MIMO filter
174X, 174Y carrier phase compensation filter
175X, 175Y 2×1 WL MIMO filter
176 2×2 SL MIMO filter
177X, 177Y 1×1 SL SISO filter
178 2×2 SL MIMO filter
179 in-transmitter nonlinear distortion compensation filter
181X, 181Y 2×1 WL MIMO filter
182X, 182Y chromatic dispersion compensation filter
183 2×2 SL MIMO filter
184X, 184Y carrier phase compensation filter

What is claimed is:

1. A distortion estimation device comprising:
at least one memory storing instructions; and
at least one processor configured to execute the instructions to:
performs equalization processing on a signal to which nonlinear distortion is applied in at least one of a transmitter, a transmission path, or a receiver, the signal being received, by the receiver by using an equalization filter that includes an in-receiver distortion compensation filter that compensates for in-receiver distortion occurring in a polarization-multiplexed signal in the receiver that receives the polarization-multiplexed signal transmitted from the transmitter via the transmission path, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter;
adaptively control filter coefficients of the in-receiver distortion compensation filter, the transmission path distortion compensation filter, and the in-transmitter distortion compensation filter; and
detect the in-receiver distortion based on the filter coefficients of the in-receiver distortion compensation filter, and detect the in-transmitter distortion based on the filter coefficients of the in-transmitter distortion compensation filter, after convergence of the filter coefficients.

2. The distortion estimation device according to claim 1, wherein the transmission path distortion compensation filter includes a first polarization rotation compensation filter that compensates for polarization rotation, a delay compensation filter that compensates for a delay for each polarized wave, and a second polarization rotation compensation filter that compensates for polarization rotation.

3. The distortion estimation device according to claim 2, wherein the transmission path distortion compensation filter includes a plurality of sets of the delay compensation filter and the second polarization rotation compensation filter.

4. The distortion estimation device according to claim 2, wherein each of the first polarization rotation compensation filter and the second polarization rotation compensation filter is a one-tap 2×2 Multiple-Input and Multiple-Output (MIMO) equalizer.

5. The distortion estimation device according to claim 1, wherein the transmission path distortion compensation filter includes a multi-tap 2×2 MIMO equalizer.

6. The distortion estimation device according to claim 1, wherein
the transmitter includes a digital analog converter that converts a digital signal into an analog signal, an electrical amplifier that amplifies an output signal of the digital analog converter, and a modulator that modulates a signal in accordance with a signal amplified by the electrical amplifier, and
the nonlinear distortion is applied to the signal by at least one of saturating an output level of the digital analog converter, saturating an input level of the electrical amplifier, saturating a gain of the electrical amplifier, or saturating an input level of the modulator, in the transmitter.

7. The distortion estimation device according to claim 1, wherein
the transmission path includes an optical fiber for transmitting the polarization-multiplexed signal, and
the nonlinear distortion is applied to the signal by causing the optical fiber in the transmission path to have an optical Kerr effect.

8. The distortion estimation device according to claim 1, wherein
the receiver includes a detector that coherently receives the polarization-multiplexed signal, an electrical amplifier that amplifies an analog signal output from the detector, and an analog digital converter that converts the analog signal amplified by the electrical amplifier into a digital signal, and
the nonlinear distortion is applied to the signal by at least one of saturating an input level of the electrical amplifier, saturating a gain of the electrical amplifier, or saturating an input level of the analog digital converter, in the receiver.

9. The distortion estimation device according to claim 1, wherein
the receiver includes an equalization signal processing circuit including the in-receiver distortion compensation filter that compensates for the in-receiver distortion occurring in the receiver, and
the at least one processor is configured to execute the instructions to control coefficients of the in-receiver distortion compensation filter of the equalization signal processing circuit in accordance with the detected in-receiver distortion.

10. The distortion estimation device according to claim 9, wherein
the transmitter includes a pre-equalization filter that pre-equalizes a polarization-multiplexed signal to be output to the transmission path, and
the at least one processor is configured to execute the instructions to control coefficients of the pre-equalization filter in accordance with the detected in-transmitter distortion.

11. The distortion estimation device according to claim 1, wherein the equalization filter further includes a carrier phase compensation filter and a chromatic dispersion compensation filter.

12. A receiver comprising:
a detector that coherently receives a polarization-multiplexed signal transmitted from a transmitter via a transmission path; and
a distortion estimation device that detects distortion included in a signal based on the coherently received polarization-multiplexed signal,
wherein the distortion estimation device comprises at least one memory storing instructions; and at least one processor configured to execute the instructions to;
perform equalization processing on the signal to which nonlinear distortion is applied in at least one of the transmitter, the transmission path, or the receiver, by using an equalization filter that includes an in-receiver distortion compensation filter that compensates for in-receiver distortion occurring in the polarization-multiplexed signal in the receiver, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter, and
adaptively control filter coefficients of the in-receiver distortion compensation filter, the transmission path distortion compensation filter, and the in-transmitter distortion compensation filter, and
detect the in-receiver distortion based on the filter coefficients of the in-receiver distortion compensation filter, and detect the in-transmitter distortion based on the filter coefficients of the in-transmitter distortion compensation filter, after convergence of the filter coefficients.

13. The receiver according to claim 12, wherein the transmission path distortion compensation filter includes a first polarization rotation compensation filter that compensates for polarization rotation, a delay compensation filter that compensates for a delay for each polarized wave, and a second polarization rotation compensation filter that compensates for polarization rotation.

14. The receiver according to claim 13, wherein the transmission path distortion compensation filter includes a plurality of sets of the delay compensation filter and the second polarization rotation compensation filter.

15. The receiver according to claim 12, wherein
the transmitter includes a digital analog converter that converts a digital signal into an analog signal, an electrical amplifier that amplifies an output signal of the digital analog converter, and a modulator that modulates a signal in accordance with a signal amplified by the electrical amplifier, and
the nonlinear distortion is applied to the signal by at least one of saturating an output level of the digital analog converter, saturating an input level of the electrical amplifier, saturating a gain of the electrical amplifier, or saturating an input level of the modulator, in the transmitter.

16. The receiver according to claim 12, wherein
the receiver includes an equalization signal processing circuit including the in-receiver distortion compensation filter that compensates for the in-receiver distortion occurring in the receiver, and
the at least one processor is configured to execute the instructions to control coefficients of the in-receiver distortion compensation filter of the equalization signal processing circuit in accordance with the detected in-receiver distortion.

17-22. (canceled)

23. A distortion estimation method comprising:
performing equalization processing on a signal to which nonlinear distortion is applied in at least one of a transmitter, a transmission path, or a receiver, the signal being received by the receiver, by using an equalization filter that includes an in-receiver distortion compensation filter that compensates for in-receiver distortion occurring in a polarization-multiplexed signal in the receiver that receives the polarization-multiplexed signal transmitted from the transmitter via the transmission path, a transmission path distortion compensation filter that compensates for distortion occurring in the polarization-multiplexed signal in the transmission path, and an in-transmitter distortion compensation filter that compensates for in-transmitter distortion occurring in the polarization-multiplexed signal in the transmitter;
adaptively controlling filter coefficients of the in-receiver distortion compensation filter, the transmission path distortion compensation filter, and the in-transmitter distortion compensation filter; and
detecting the in-receiver distortion based on the filter coefficients of the in-receiver distortion compensation filter, and detecting the in-transmitter distortion based on the filter coefficients of the in-transmitter distortion compensation filter, after convergence of the filter coefficients.

24. The distortion estimation method according to claim 23, wherein
the receiver includes an equalization signal processing circuit including the in-receiver distortion compensation filter that compensates for the in-receiver distortion occurring in the receiver, and
the distortion estimation method further comprises controlling coefficients of the in-receiver distortion compensation filter of the equalization signal processing circuit included in the receiver in accordance with the detected in-receiver distortion.

25. The distortion estimation method according to claim 24, wherein
the transmitter includes a pre-equalization filter that pre-equalizes a polarization-multiplexed signal to be output to the transmission path, and
the distortion estimation method further comprises controlling coefficients of the pre-equalization filter in accordance with the detected in-transmitter distortion.

26. (canceled)
